(19) United States
(12) Patent Application Publication
(10) Pub. No.: US 2010/0073808 A1
(43) Pub. Date: Mar. 25, 2010

(54) POSITION SENSING IN DISCRETE TRACK RECORDING

(75) Inventors: Walter Richard Eppler, Cranberry Township, PA (US); Mark David Bedillion, Allison Park, PA (US); Darren William Karns, Evans City, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/235,962

(22) Filed: Sep. 23, 2008

(51) Int. Cl. G11B 5/596

(52) U.S. Cl. 360/77.02; G9B/5.216

(57) ABSTRACT

In a particular embodiment, a storage system is disclosed that includes a discrete track media having a plurality of concentric data tracks to store data and including a respective plurality of non-magnetic regions to separate adjacent data tracks. The non-magnetic regions include encoded position information. The storage system further includes a controller adapted to adjust a position of a read/write head relative to a center of a particular track based on the encoded position information.

### FIELD

The present disclosure relates generally to position sensing in discrete track recording, and more particularly to position sensing in discrete track recording using groove modulation.

### BACKGROUND

Discrete track media (DTM) includes patterned data tracks that can be used by a servo system to align a read/write head to particular data tracks. Unlike perpendicular and longitudinal magnetic recording in which data track trajectories could be defined independently of servo-pattern trajectories, in DTM recording, it is desirable that both the servo pattern trajectories and the data pattern trajectories match. Unfortunately, the servo position information may not be well-aligned to the data tracks.

Embodiments described below provide solutions to these and other problems, and offer other advantages over the prior art.

### SUMMARY

In a particular embodiment, a storage system is disclosed that includes a discrete track media having a plurality of concentric data tracks to store data and including a respective plurality of non-magnetic regions to separate adjacent data tracks. The non-magnetic regions include encoded position information. The storage system further includes a controller adapted to adjust a position of a read/write head relative to a center of a particular track based on the encoded position information.

In another particular embodiment, a method is disclosed that includes detecting first and second position information encoded at first and second grooves adjacent to a particular data track of a discrete track media and determining a position error of a read/write head relative to a center of the particular data track based on the first and second position information. The method further includes adjusting the position of a read/write head toward the center of the particular data track based on the determined position error.

In still another particular embodiment, a recording medium includes a plurality of patterned data tracks to store data and a respective plurality of non-magnetic regions to store servo position information, which can be used to determine a servo position error. Each data track of the plurality of patterned data tracks is separated from adjacent data tracks by at least one non-magnetic region.

Other features and benefits that characterize embodiments will be apparent upon reading the following detailed description and review of the associated drawings.

### BRIEF DESCRIPTION OF THE DRAWINGS

FIG. 1 is a top view of a representative embodiment of a particular discrete track media including zero acceleration path information (ZAP) servo fields to correct for servo/data mis-registration;

FIG. 2 is a top view of a particular illustrative embodiment of a portion of a discrete track media including grooves between adjacent tracks to store servo position data;

FIG. 3 is graph illustrating cross-track versus downtrack directions for a particular illustrative embodiment of a representative portion of a discrete track media including different frequencies used to encode position data in grooves between adjacent tracks;

FIG. 4 is an isometric view of a particular illustrative embodiment of a system including a disc drive having a discrete track media with grooves that include encoded positioning information;

FIG. 5 is a flow diagram of a particular illustrative embodiment of a method of using groove modulation to sense a position of a read/write head relative to a particular track of a discrete track media; and

FIG. 6 is a flow diagram of a second particular illustrative embodiment of a method of using groove modulation to sense a position of a read/write head relative to a particular track of a discrete track media.

### DETAILED DESCRIPTION OF ILLUSTRATIVE EMBODIMENTS

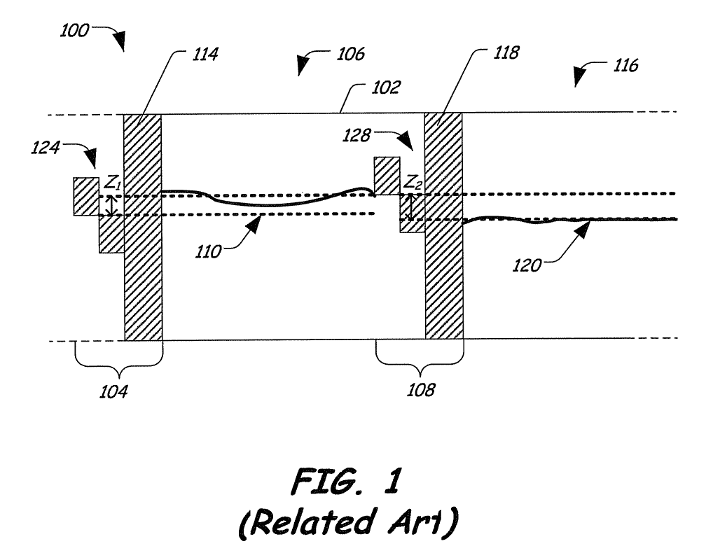

FIG. 1 is a block diagram of a representative embodiment of a particular discrete track media 100 including servo wedges 104 and 108. The servo wedge 104 includes a first continuous media region 114 and first “servo burst” information 124. The servo wedge 108 includes a second continuous media region 118 and second “servo burst” information 128. The servo wedges 104 and 108 provide zap-type servo information that can be used to correct for servo/data mis-registration. The discrete track media 100 includes data fields including a first portion 106 and a second portion 116, which are separated by the servo wedge 108. The first and second “servo burst” information 124 and 128 can include information used to detect a fine position of a read/write head relative to a center of a data track, such as the center of the data tracks 110 and 120. The continuous media regions 114 and 118 are used to store zero-acceleration path (“zap”) information that represents to the servo system how a position of a particular data track differs from a position of the center of the “servo burst” information. For example, the zap information at the second continuous media region 118 represents to the servo system how a position of the data track 110 differs from a position of a center of the second “servo burst” information 118. In a particular embodiment, the servo wedges 104 and 108 can include servo preamble information (not shown) that includes information identifying the particular track from which the read/write head is retrieving data. The first portion 106 includes a data track portion 110 and the second portion 116 includes a second data track portion 120.

Servo patterns that include the first and second wedges 104 and 108 include only direct-current (DC) information. During fabrication, it may not be possible to selectively flip bits. Nevertheless, a DC-erased disc should be capable of providing a signal that can be used by a servo controller for positioning an associated read/write head. However, a DC-erased pattern can reduce readback signal amplitude from the first and second “servo burst” information 124 and 128 by a factor of two and can create transients as the AC-coupled read/write head moves from the first portion 106 across the servo wedge 108 to the second portion 116, for example. Such transients can be mitigated by re-polarizing the servo pattern during certification, but such re-polarization can increase the factory time, by at least 4n revolutions, where n represents a number of tracks to be written.

In a particular instance, a trajectory of the servo patterns may not be aligned with the data pattern trajectory. The servo pattern is written in separate passes from the data tracks, and the trajectory written to the data tracks can vary from the trajectory (position information) written to the servo tracks. The zap-type servo fields (i.e., the first and second continuous media regions 114 and 118) can be used to correct for such misalignment. To perform such correction, the read/write head must measure offsets (Z₁ and Z₂), which may not be trivial. Trajectory corrections using such offsets can only occur at the servo update rate, which means that high frequency trajectory deviations may be ignored at the expense of signal-to-noise ratio (SNR). Alternatively, a servo update rate can be increased by providing more servo wedges, which reduces a format efficiency of the discrete track media 100.

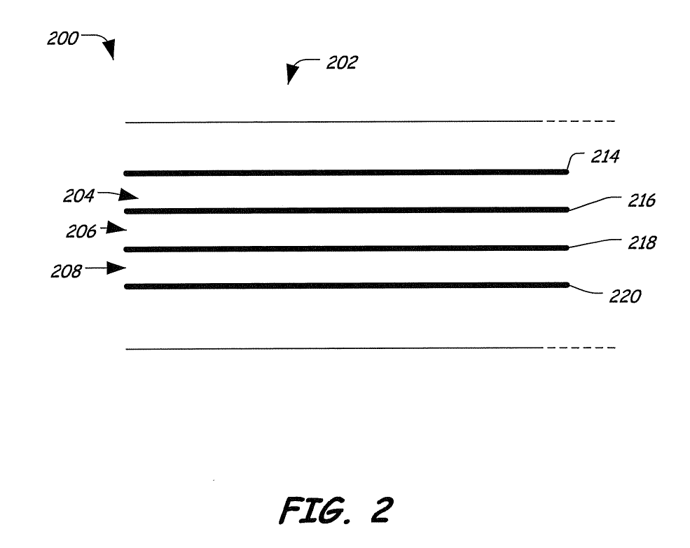

FIG. 2 is a top view of a particular illustrative embodiment of a portion of a discrete track media 200 including grooves (non-magnetic regions) between adjacent data tracks that store servo position data. The discrete track media 200 includes a first portion 202 that includes a first data track 204 with a first adjacent groove (non-magnetic region) 214 and a second adjacent groove (non-magnetic region) 216, where the first and second adjacent grooves 214 and 216 include encoded servo position information. The discrete track media 200 further includes a second data track 206 and a third adjacent groove 218, and includes a third data track 208 and a fourth adjacent groove 220. The third and fourth adjacent grooves 218 and 220 also include encoded servo position information. While only three data tracks 204, 206, and 208 are illustrated, it should be understood that the discrete track media 200 can include any number of data tracks.

In a particular embodiment, the first, second, third, and fourth servo position information may be encoded using frequency modulation, phase modulation, or any combination thereof. In another particular embodiment, the first adjacent groove 214 can include servo position information that is encoded with a first frequency and the second adjacent groove 216 can include servo position information that is encoded with a second frequency. In a particular example, the frequency encoding may follow a pattern that alternates between two frequencies or that uses a repeating pattern of three or more frequencies. In another particular example, each groove may be encoded with servo position information using a unique frequency. In still another particular embodiment, instead of or in addition to using frequency modulation, the servo position information can be encoded using phase modulation, by applying alternating phases, patterns of phases, or unique phases to the multiple grooves.

In a particular example, a storage device can include a controller that is adapted to determine a position error of an associated read/write head relative to a center of a recording track, such as the first data track 204, based on a difference in relative amplitudes of the readback signals associated with the first and second servo position information.

A particular advantage provided by encoding the servo position information into the grooves between adjacent data tracks, such as the grooves 214 and 216, is that trajectory corrections for the read/write head can be made at a much higher frequency than traditional servo wedge (zap-type field) adjustments, allowing the controller to correct for higher-order pattern distortions. Further, the groove-modulation technique eliminates the need for traditional servo patterns and allows for generation of positioning information in the same passes that define the data tracks resulting in improved servo track position information alignment. Further, format efficiency can be improved by removing servo fields altogether.

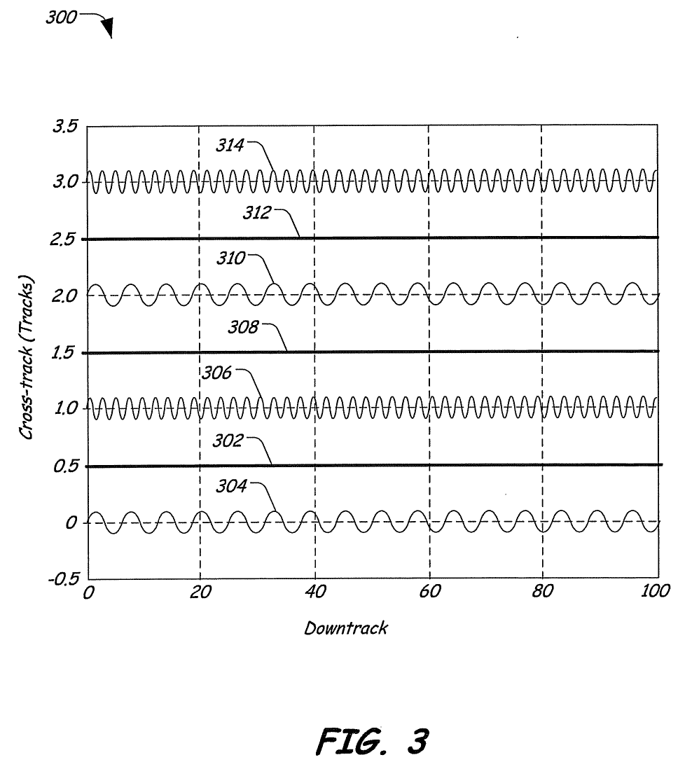

FIG. 3 is graph 300 illustrates cross-track versus downtrack directions for a particular illustrative embodiment of a representative portion of a discrete track media including different frequencies used to encode servo position data in grooves between adjacent tracks. In the graph 300, first, second, and third data tracks 302, 308, and 312 are shown at positions 0.5, 1.5, and 3.5 units, which are bounded by non-magnetic regions (grooves) at positions 0, 1, 2, and 3 units. The non-magnetic regions (grooves), at 0, 1, 2, and 3 units, store servo position information encoded using frequency modulation or phase modulation. In a particular embodiment, the first data track 302 is bounded by a first groove (at 0 units) that includes first servo position information 304 and by a second groove (at 1.0 units) that includes second servo position information 306. The second data track 308 is bounded by the second groove and by a third groove (at 2.0 units) that includes third servo position information 310. The third data track 312 is bounded by the third groove and by a fourth groove (at 3.0 units) that includes fourth servo position information 314.

In a particular embodiment, the first and second servo position information 304 and 306 are encoded at different frequencies or different phases. The third servo position information 310 can be encoded at the same frequency or phase as the first servo position information 304 if the system knows which track the head is on, which would be the case if traditional servo preambles were included. In an alternative embodiment, the third servo position information 310 can be encoded at a different frequency or phase from the first servo position information 304. In a particular example, each groove may include servo position information that is encoded at a unique frequency or phase. In another particular example, a pattern of frequencies or phases may be used in repeating blocks to encode the servo position information. In still another particular example, multiple frequencies can be used such that any combination of two frequencies from adjacent grooves can uniquely identify a particular track.

In a particular example, the first servo position information 304 is encoded at a first groove frequency (f₁) and the second servo position information 306 is encoded at a second groove frequency (f₂). In this particular example, a controller associated with a read/write head can determine its position to within a half of a width of the data track 302. The read/write head position can be fully determined by examining a relative amplitude of the two modulation frequencies according to the following equation:

$$P E S = \pm \frac{\vert {F}_{1} \vert - \vert {F}_{2} \vert}{\vert {F}_{1} \vert + \vert {F}_{2} \vert} \qquad ( Equation 1 )$$

where PES represents the position error signal and where the frequencies (F₁ and F₂) represent the readback response amplitudes at the first and second groove frequencies (f₁ and f₂). In a particular example, in Equation 1, the sign of the position error signal can alternate from track to track. In a particular embodiment, the servo position information can be patterned into the grooves using frequency or phase modulation to define the information. If advantageous, multiple frequencies can be used to differentiate the read/write head position information by modulating grooves at multiple frequencies (f₁, f₂, . . . , fₙ).

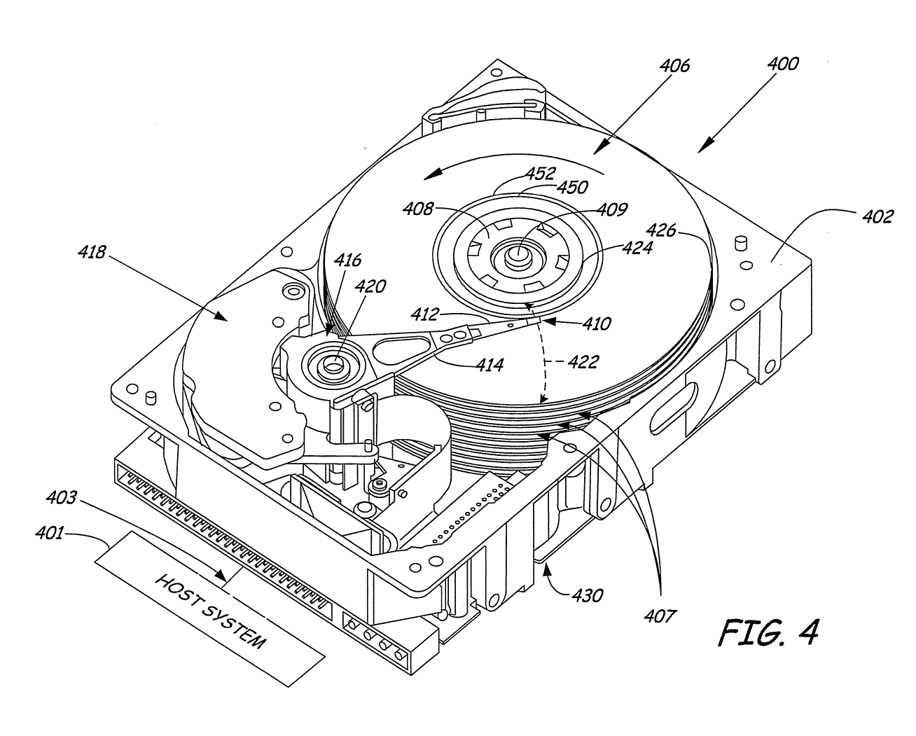

FIG. 4 is an isometric view of a disc drive 400 that includes a discrete track media (disc pack 406) with servo position information encoded at grooves between adjacent data tracks. The disc drive 400 includes a housing with a base 402 and a top cover (not shown). The disc drive 400 further includes a disc pack 406, which is mounted on a spindle motor (not shown) by a disc clamp 408. Disc pack 406 includes a plurality of individual discs 407, which are mounted for co-rotation about central axis via a spindle 409. Each disc surface has an associated disc head slider 410 which is mounted to the disc drive 400 for communication with the disc surface. The individual discs 407 include multiple data tracks, such as the data tracks 450 and 452 with servo position information encoded into adjacent grooves.

In the example shown in FIG. 4, disc head sliders 410 are supported by suspensions 412 which are in turn attached to track accessing arms 414 of an actuator 416. The actuator shown in FIG. 4 is of the type known as a rotary moving coil actuator and includes a voice coil motor (VCM), shown generally at 418. The VCM 418 rotates actuator 416 with its attached disc head slider 410 about a pivot shaft 420 to position the disc head slider 410 over a desired data track along an arcuate path 422 between a disc inner diameter 424 and a disc outer diameter 426. The VCM 418 is driven by servo electronics 430 based on signals generated by read/write heads mounted to the disc head sliders 410 and a host computer (not shown).

The servo electronics 430 include control circuitry, sometimes referred to as a controller, to determine relative amplitudes of groove modulated servo position information read by the read/write head at the disc head slider 410 to determine a position of the disc head slider 410 relative to a center of a particular data track. In a particular embodiment, each groove includes respective servo position information encoded using frequency modulation, phase modulation, or any combination thereof.

In a particular example, by encoding the servo position information in the same pass that defines the data tracks, the fabrication process is simplified. Further, the servo position information can be more accurate because the servo position information is written when the track is defined. Additionally, by using groove modulation, the servo wedges can be eliminated, improving format efficiency.

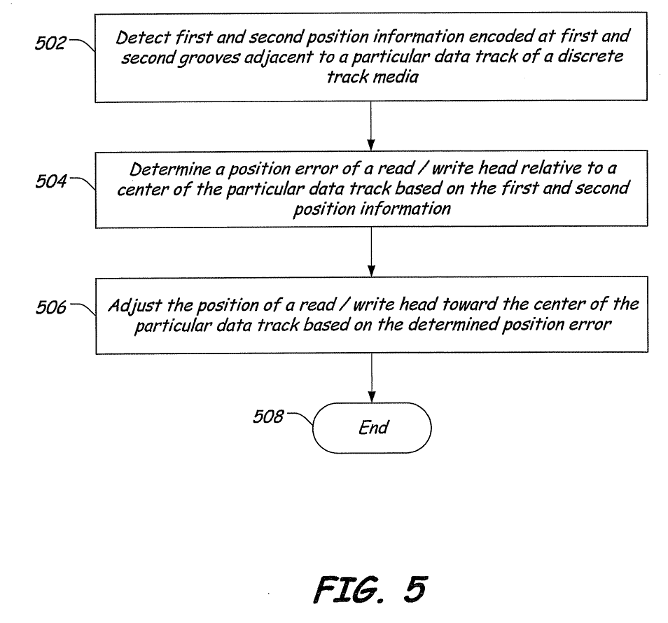

FIG. 5 is a flow diagram of a particular illustrative embodiment of a method of using groove modulation to sense a position of a read/write head relative to a particular track of a discrete track media. At 502, first and second position information is detected that is encoded at first and second grooves adjacent to a particular data track of a discrete track media. In a particular embodiment, the first and second position information are encoded using phase modulation, frequency modulation, or any combination thereof. In a particular example, the first position information is encoded at a first frequency, and the second position information is encoded at a second frequency. Advancing to 504, a position error of a read/write head relative to a center of the particular data track is determined based on the first and second position information. In a particular embodiment, the position error of the read/write head is determined by determining a difference between a first amplitude associated with the first position information and a second amplitude associated with the second position information, and by dividing the difference by a sum of the first amplitude and the second amplitude to produce the position error. Continuing to 506, the position of a read/write head is adjusted toward the center of the particular data track based on the determined position error. The method terminates at 508.

In a particular embodiment, by encoding the servo position information in the groove between adjacent data tracks, traditional servo patterns can be eliminated, enhancing format efficiency of the discrete track media. Further, the controller can utilize the position information to adjust for higher-order pattern distortions, which might otherwise be ignored if only zap-type servo bursts were used. In this particular example, overall performance of the servo controller is improved using the encoded servo position information.

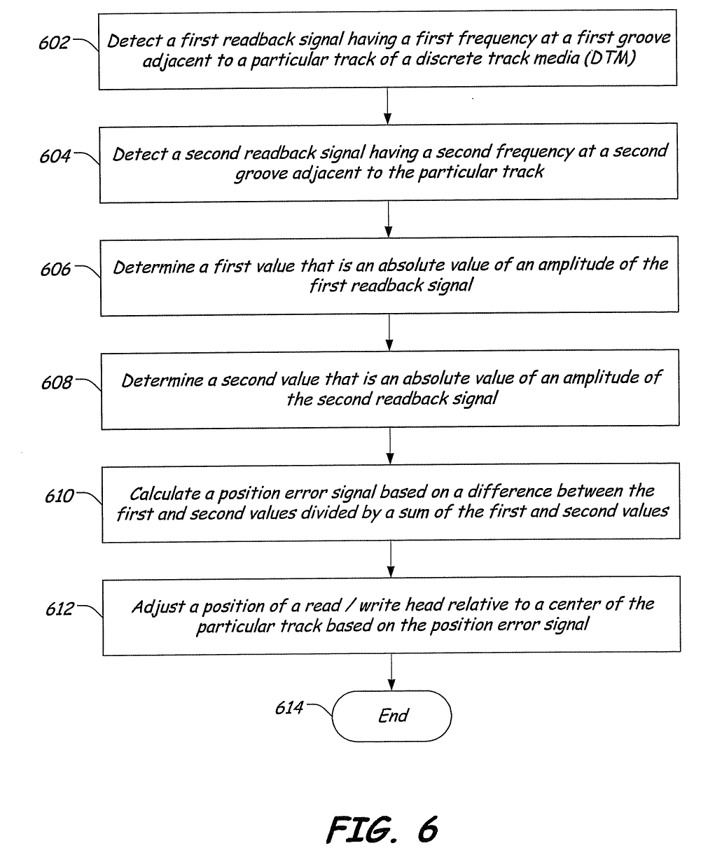

FIG. 6 is a flow diagram of a second particular illustrative embodiment of a method of using groove modulation to sense a position of a read/write head relative to a particular track of a discrete track media. At 602, a first readback signal having a first frequency is detected at a first groove adjacent to a particular track of a discrete track media (DTM). Advancing to 604, a second readback signal having a second frequency is detected at a second groove adjacent to the particular track. Moving to 606, a first value is determined that is an absolute value of an amplitude of the first readback signal. Continuing to 608, a second value is determined that is an absolute value of an amplitude of the second readback signal. Proceeding to 610, a position error signal is calculated based on a difference between the first and second values divided by a sum of the first and second values. Moving to 612, a position of a read/write head relative to a center of the particular track is adjusted based on the position error signal. The method terminates at 614.

In this particular example, it is implicitly assumed that it is known in what direction to proceed. In particular, it is known whether a first track with a first frequency (F1) was on the top or the bottom (from a top view perspective). In a particular example, such information can be known if the information can be determined from a servo preamble or if the frequencies are structured such that lo the combination of a first frequency (F1) and a second frequency (F2) uniquely identifies a track. In a particular embodiment, the pattern of groove frequencies may be controlled such that a particular combination of frequencies uniquely identifies a particular track.

In conjunction with the systems, methods and discrete track recording media described above with respect to FIGS. 2-6, grooves (non-magnetic regions) of a patterned discrete track media are modulated to encode servo positioning information, which can be used by a read/write head to determine its position relative to a center of a data track between two grooves. The grooves can be modulated using phase modulation, frequency modulation, or any combination thereof. The position of the read/write head relative to the center of the track can be determined from the position information modulated into the grooves, which separate adjacent data tracks.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the discrete track media recording system while maintaining substantially the same functionality without departing from the scope and spirit of the present invention. In addition, although an embodiment described herein is directed to a disc drive system having a discrete track media patterned with data tracks and adjacent grooves including servo positioning information, it will be appreciated by those skilled in the art that the teachings of the present invention can be applied to other discrete track positioning systems, without departing from the scope and spirit of the present invention.

What is claimed is:

1. A storage system comprising:
a discrete track media including a plurality of concentric data tracks to store data and including a respective plurality of non-magnetic regions to separate adjacent data tracks, the non-magnetic regions including encoded position information; and
a controller adapted to adjust a position of a read/write head relative to a center of a particular track based on the encoded position information.

2. The storage system of claim 1, wherein a particular data track is bounded by first and second non-magnetic regions.

3. The storage system of claim 2, wherein the first non-magnetic region includes first position information and wherein the second non-magnetic region includes second position information.

4. The storage system of claim 3, wherein the first position information and the second position information are encoded at different frequencies.

5. The storage system of claim 1, wherein the discrete track media is patterned without servo wedges.

6. The storage system of claim 1, wherein the controller determines a position error based on a relative amplitude of a first readback signal and a second readback signal related to the first and second position information, respectively.

7. The system of claim 1, wherein the position information is encoded using phase modulation encoding.

8. The system of claim 1, wherein the position information is encoded using frequency modulation.

9. A method comprising:
detecting first and second position information encoded at first and second grooves adjacent to a particular data track of a discrete track media;
determining a position error of a read/write head relative to a center of the particular data track based on the first and second position information; and
adjusting the position of a read/write head toward the center of the particular data track based on the determined position error.

10. The method of claim 9, wherein the first and second position information are encoded using phase modulation.

11. The method of claim 9, wherein the first and second position information are encoded using frequency modulation.

12. The method of claim 11, wherein the first position information is encoded at a first frequency, and wherein the second position information is encoded at a second frequency.

13. The method of claim 9, wherein determining the position error of the read/write head comprises determining a difference between a first amplitude associated with the first position information and a second amplitude associated with the second position information.

14. The method of claim 13, further comprising dividing the difference by a sum of the first amplitude and the second amplitude to produce the position error.

15. A recording medium comprising:
a plurality of patterned data tracks to store data;
a respective plurality of non-magnetic regions to store servo position information that can be used to determine a servo position error;
wherein each data track of the plurality of patterned data tracks is separated from adjacent data tracks by at least one non-magnetic region.

16. The recording medium of claim 15, wherein the servo position information is encoded at the respective plurality of non-magnetic regions using multiple frequencies such that the servo position information for each data track of the plurality of data tracks is encoded at the non-magnetic regions at different frequencies.

17. The recording medium of claim 15, wherein a first data track of the plurality of patterned data tracks has a first and second non-magnetic regions of the respective plurality of non-magnetic regions that define circumferential boundaries of the first data track.

18. The recording medium of claim 17, further comprising:
a second data track of the plurality of patterned data tracks; and
a third non-magnetic region of the respective plurality of non-magnetic regions;
wherein the second non-magnetic region and the third non-magnetic region define circumferential boundaries of the second data track; and
wherein the third non-magnetic regions stores third servo position information.

19. The recording medium of claim 18, wherein the first, second, and third servo position information are encoded using at least one of frequency modulation and phase modulation.

20. The recording medium of claim 17, wherein the servo position information at each of the respective plurality of non-magnetic regions is encoded at a unique frequency.

21. The recording medium of claim 17, wherein the servo position information stored at the respective plurality of non-magnetic regions is encoded using a repeating pattern of frequencies such that each non-magnetic region stores the servo position information encoded at a selected frequency from the repeating pattern of frequencies.
